(19) United States
(12) Patent Application Publication
(10) Pub. No.: US 2007/0115821 A1
(43) Pub. Date: May 24, 2007

(54) METHOD FOR TRANSMITTING WIRELESS DATA USING PIGGYBACK

(75) Inventors: Sang Hyun Sim, Seoul (KR); Soon Jin Choi, Kyungki-do (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/550,931

(22) Filed: Oct. 19, 2006

(30) Foreign Application Priority Data
Oct. 26, 2005 (KR) 10-2005-101482

(51) Int. Cl. H04L 12/26

(52) U.S. Cl. 370/231

(57) ABSTRACT

A method for transmitting wireless data using a piggyback technique includes the steps of: a) transmitting a predetermined request packet from a first communication unit to a second communication unit in a predetermined wireless network system; b) determining, by the second communication unit having received the request packet, whether to sequentially transmit an acknowledgement (ACK) packet indicating an acknowledged or unacknowledged state of the request packet and a data packet responding to the request packet to the first communication unit; and c) if it is determined that the ACK packet and the data packet should be sequentially transmitted, including, by the second communication unit, ACK information in a header of the data packet without transmitting the ACK packet to the first communication unit, and transmitting the data packet including the header equipped with the ACK information to the first communication unit.

### RELATED APPLICATION

The present application is based on, and claims priority from, Korean Application Number 2005-101482, filed Oct. 26, 2005, the disclosure of which is incorporated by reference herein in its entirety.

### BACKGROUND OF THE INVENTION

1. Field of the Invention

The present invention relates to a method for transmitting wireless data from a one device to another device of a wireless network system, and more particularly to a method for transmitting wireless data using a piggyback technique, which includes an acknowledgement (ACK) field in a header of a data packet, includes specific information indicating the acknowledged or unacknowledged state in the data packet, sequentially transmits an acknowledgement (ACK) packet and the data packet equipped with the specific information from a one device to another device of a wireless network, and therefore reduces a packet transmission/reception time of a network and an amount of power consumption of the network.

2. Description of the Related Art

Typically, ZigBee acting as a representative WPAN (Wireless Personal Area Network) technology is a personal wireless network standard for 2.4 GHz-based home-automation or data of 2.4 GHz at which characteristics of low power, low cost, and low speed are implemented. The ZigBee has been standardized at an IEEE 802.15.4 protocol.

Referring to the above-mentioned ZigBee standard, the ZigBee uses a variety of frequency bands of 2.4 GHz, 915 MHz, and 868 MHz. The frequency band of 2.4 GHz (i.e., at 2.4 GHz ISM band) may have a transfer rate of 250 Kbps, and may also have 16 channels. The frequency band of 916 MHz may have a transfer rate of 40 Kbps, and may also have 10 channels. The frequency band of 868 MHz may have a transfer rate of 20 Kbps, and may also have a single channel. A modem scheme transmits data at a transfer rate of 20˜250 kbps within a radius of 30 m using a DSSS (Direct Secure Spread Spectrum), and connects a maximum of 255 devices to a single wireless network, such that it can configure a large-sized wireless sensor network indoors or outdoors.

Compared with other WPAN technologies (e.g., Bluetooth or UWB (Ultra Wide Band)), the above-mentioned ZigBee implements super-low power consumption, simplifies the configuration of a wireless transmission/reception circuit, and therefore implements the cheapest chip-set. As a result, the ZigBee is considered to be a competitive short-range wireless communication technology in a vertical application area such as a sensor network.

For example, if the ZigBee is introduced to a variety of systems (i.e., an illumination system, a fire detection system, and a cooling/heating system, etc.) of a building, an administrator or manager of the building can manage or control all the systems of the building at a remote site using a mobile device such as a remote-controller.

The wireless private network using the above-mentioned ZigBee may include a network coordinator and a plurality of network devices. The network coordinator is contained in a computer or a main controller of a home network, and controls data transmission/reception operations among the network devices. The network devices serve as I/O (Input/Output) parts of actual data.

In the case of the home-automation system, a heating system, a ventilation system, an air-conditioner, a security system, and electric lights or sensors correspond to the above-mentioned network devices, respectively. In other words, the wireless private network using the ZigBee is operated by the data transmission/reception operations between the network coordinator and each of the network devices. In this case, the data is configured in the form of a packet. For the convenience of description and better understanding of the present invention, it should be noted that the term “wireless data” is equal to the term “packet” or “wireless packet”.

FIG. 1 is a conceptual diagram illustrating a packet transmission/reception method between a network device and a network coordinator during an association process for configuring a network of a conventional ZigBee system.

Referring to FIG. 1, if the network device 11 transmits an association request packet (also called an associate request packet) to the network coordinator 12 at step S11, the network coordinator 12 receives the association request packet from the network device 11, and transmits an acknowledgement (ACK) packet for confirming the reception of the association request packet to the network device 11. The network device 11 receives the ACK packet from the network coordinator 12, and transmits a data request packet to the network coordinator 12 at step S13.

Upon receiving the data request packet from the network device 11, the network coordinator 12 transmits an ACK packet for confirming the reception of the data request packet to the network device 11 at step S14, and transmits an association response packet (also called an associate response packet) to the network device 11 after the lapse of a predetermined time Td.

Upon receiving the association response packet from the network coordinator 12, the network device 11 transmits an ACK packet for confirming the reception of the association response packet to the network coordinator 12, such that the network configuration is completed.

During the above-mentioned packet transmission process between the network device 11 and the network coordinator 12, the network coordinator 12 transmits the ACK packet for confirming the reception of the data request packet to the network device 11 at step S14, and transmits an association response packet to the network device 11 after the lapse of a predetermined time Td.

In this way, if the data packet such as the aforementioned association response packet is transmitted after the ACK packet has been transmitted, and a predetermined time delay Td occurs between transmission times of the two packets (i.e., the ACK packet and the association response packet), resulting in the occurrence of unnecessary-time consumption. Also, in order to determine whether data is received or not, an ACK packet acting as a single complete packet (e.g., 11-byte packet) must be firstly transmitted, and a data packet must then be transmitted, such that the network device 11 and the network coordinator 12 must unnecessarily consume a large amount of power to sequentially transmit the ACK and data packets.

### SUMMARY OF THE INVENTION

Therefore, the present invention has been made in view of the above problems, and it is an object of the present invention to provide a method for transmitting wireless data using a piggyback technique, which includes an acknowledgement (ACK) field in a header of a data packet, includes specific information indicating the acknowledged or unacknowledged state in the data packet, sequentially transmits an acknowledgement (ACK) packet and the data packet equipped with the specific information from a one device to another device of a wireless network, and therefore reduces a packet transmission/reception time of a network and an amount of power consumption of the network.

In accordance with one aspect of the present invention, the above and other objects can be accomplished by the provision of a method for transmitting wireless data using a piggyback technique comprising the steps of: a) transmitting a predetermined request packet from a first communication unit to a second communication unit in a predetermined wireless network system; b) determining, by the second communication unit having received the request packet, whether to sequentially transmit an acknowledgement (ACK) packet indicating an acknowledged or unacknowledged state of the request packet and a data packet responding to the request packet to the first communication unit; and c) if it is determined that the ACK packet and the data packet should be sequentially transmitted, including, by the second communication unit, ACK information in a header of the data packet without transmitting the ACK packet to the first communication unit, and transmitting the data packet including the header equipped with the ACK information to the first communication unit.

Preferably, the wireless network system is a ZigBee system.

Preferably, the first communication unit is a network device and the second communication unit is a network coordinator, or the first communication unit is the network coordinator and the second communication unit is the network device.

Preferably, the ACK information is contained in a frame control field of the header.

Preferably, the ACK information is represented by only one bit from among a plurality of reserved bits contained in the frame control field.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual diagram illustrating a packet transmission/reception method between a network device and a network coordinator during an association process for configuring a network of a conventional ZigBee system;

FIG. 2 is a conceptual diagram illustrating a packet transmission/reception method between a network device and a network coordinator of a ZigBee system using a packet transmission method based on a piggyback technique according to the present invention;

FIG. 3 is a configuration diagram illustrating a general data packet frame; and

FIG. 4 exemplarily shows a ZigBee data packet frame according to the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

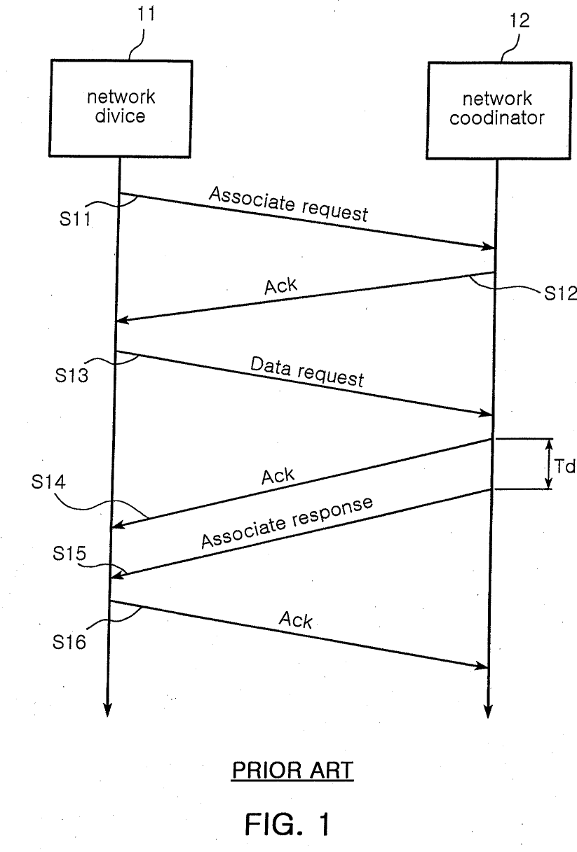

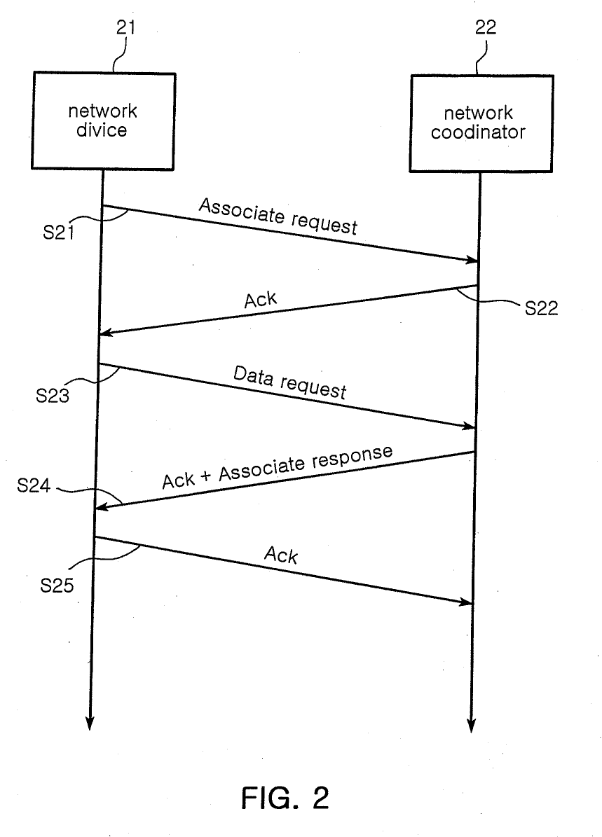

FIG. 2 is a conceptual diagram illustrating a packet transmission/reception method between a network device and a network coordinator of a ZigBee system using a packet transmission method based on a piggyback technique according to the present invention. Similar to FIG. 1, FIG. 2 is a conceptual diagram illustrating a packet transmission/reception method between a network device and a network coordinator during an association process for configuring a network of a ZigBee system according to the present invention.

Referring to FIG. 2, the network device 21 transmits an association request packet to the network coordinator 22 at step S21.

The network coordinator 22 receives the association request packet from the network device 21, and determines whether to sequentially transmit an acknowledgement (ACK) packet indicating an acknowledged or unacknowledged state of the association request packet and a data packet responding to the ACK packet to the network device 21. There is no need for the network coordinator 22 to transmit other data packets after transmitting the ACK packet, such that the network coordinator 22 transmits the ACK packet indicating the acknowledged or unacknowledged state of the association request packet to the network device 21 at step S22.

Upon receiving the ACK packet from the network coordinator 22, the network device 21 transmits a data request packet to the network coordinator 22 at step S23.

Thereafter, the network coordinator receives the data request packet, and determines whether to sequentially transmit the ACK packet indicating the acknowledged or unacknowledged state of the data request packet and a data packet responding to the ACK packet to the network device 21. In this case, the network coordinator 22 must firstly transmit the ACK packet indicating the acknowledged or unacknowledged state of the data request packet, and must secondly transmit the association response packet. Therefore, the network coordinator 22 includes ACK information in a header of the association response packet, without transmitting the ACK packet equipped with information indicating the acknowledged or unacknowledged state of the data request packet, to the network device 21, such that it transmits the association response packet including the ACK information at step S24.

The network device 21 reads ACK information contained in the header of the association response packet, and recognizes that the network coordinator 22 has received the data request packet transmitted from the network device 21 itself, and transmits an ACK packet indicating the acknowledged or unacknowledged state of the association response packet to the network coordinator 22, such that the network configuration is completed.

The above-mentioned description has disclosed an exemplary ZigBee system according to the present invention. Particularly, the above-mentioned description has disclosed the association process capable of constructing the network in the ZigBee system. However, it is well known to those skilled in the art that other communication processes of the ZigBee system can be applied to general wireless packet communication technologies.

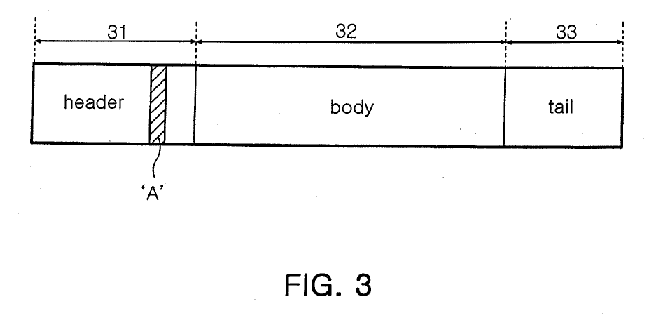

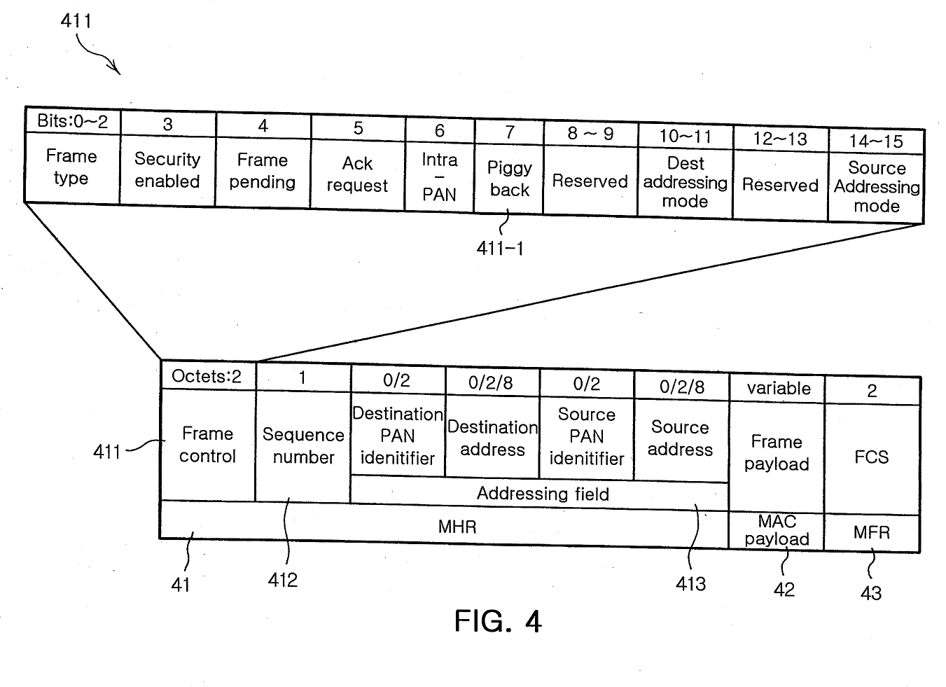

A method for including ACK information in the header of the association response packet without transmitting the ACK packet, and transmitting the resultant association response packet including the ACK information to the network device 21 will hereinafter be described with reference to FIGS. 3 and 4.

FIG. 3 is a configuration diagram illustrating a general data packet frame. In more detail, FIG. 3 shows a packet frame for use in general wireless communication.

Referring to FIG. 3, a transmission/reception packet between communication devices available for general wireless communication includes a packet 31, a body (also called a payload) 32, and a tail (also called a footer) 33.

In the case of sequentially transmitting the ACK packet and the data packet responding to the ACK packet, the present invention is characterized in that it includes ACK information indicating an acknowledged or unacknowledged state in a part A of the header 31 of the data packet, such that the resultant data packet including the ACK information is transmitted to a destination. In other words, the ACK information is contained in the header 31 of the data packet, instead of the body 32 of the packet.

Provided that the ACK information is contained in the body 32 of the data packet, this situation may indicate that a single complete packet is required to transmit the ACK information, such that it is impossible to reduce the number of packets. However, the present invention includes the ACK information in the header of the data packet, instead of the body of the data packet, such that the number of required packets is substantially reduced.

FIG. 4 exemplarily shows a ZigBee data packet frame according to the present invention. In more detail, FIG. 4 shows a data packet frame for use in the ZigBee system according to the present invention.

Referring to FIG. 4, the packet frame for use in the ZigBee system mainly includes a MAC header (MHR) 41, a MAC payload 42, and a MAC footer 43.

The MAC header 41 includes a frame control field 411, a sequence number field 412 for indicating a sequence number of a current frame, and an addressing field 413 equipped with destination and source addresses, etc.

The frame control field 411 contained in the MAC header (MHR) 41 includes a plurality of fields indicating a frame type, etc. According to the ZigBee standard, Nos. 7, 8, and 9 bits and Nos. 12 and 13 bits of the frame control field 411 composed of 2 octets (i.e., 16 bits) are used as reserved fields including no information. Only one of the above-mentioned several reserved bits is represented by a piggyback field, and the ACK information indicating an acknowledged or unacknowledged state is contained in the piggyback field.

For example, if the value “1” is assigned to the piggyback field, the piggyback field of 1 indicates the presence of ACK information. If the value “0” is assigned to the piggyback field, the piggyback field of 0 indicates the absence of ACK information. In more detail, as can be seen from FIG. 2, the network device 21 recognizes the piggyback field in the header of the received association response packet. If the piggyback field has the value of 1, the network device 21 determines that the network coordinator 22 has received the data request packet pre-transmitted from the network device 21, and goes to the next stage.

In the case of checking the piggyback field at the header of the association response packet received in the network device 21, if the piggyback field has the value of 0, the network device 21 determines that the data request packet has not been received in the network coordinator 22, such that it may re-transmit the data request packet to the network coordinator 22.

As apparent from the above description, a packet transmission method using a piggyback technique according to the present invention can reduce the number of packets communicated between communication devices, and at the same time can reduce a communication time required for the communication of the communication devices, resulting in reduction of power consumption of the communication devices.

In this way, the packet transmission method reduces the number of packets communicated between the communication devices, reduces the communication time required for the communication of the communication devices, and reduces an amount of power consumed for a wireless communication system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for transmitting wireless data using a piggyback technique comprising the steps of:
a) transmitting a predetermined request packet from a first communication unit to a second communication unit in a predetermined wireless network system;
b) determining, by the second communication unit having received the request packet, whether to sequentially transmit an acknowledgement (ACK) packet indicating an acknowledged or unacknowledged state of the request packet and a data packet responding to the request packet to the first communication unit; and
c) if it is determined that the ACK packet and the data packet should be sequentially transmitted, including, by the second communication unit, ACK information in a header of the data packet without transmitting the ACK packet to the first communication unit, and transmitting the data packet including the header equipped with the ACK information to the first communication unit.

2. The method according to claim 1, wherein the wireless network system is a ZigBee system.

3. The method according to claim 2, wherein:
the first communication unit is a network device and the second communication unit is a network coordinator, or
the first communication unit is the network coordinator and the second communication unit is the network device.

4. The method according to claim 2, wherein the ACK information is contained in a frame control field of the header.

5. The method according to claim 4, wherein the ACK information is represented by only one bit from among a plurality of reserved bits contained in the frame control field.

6. A method for transmitting wireless data using a piggyback technique comprising the steps of:
a) transmitting, by a network device of a ZigBee system, a predetermined request packet to a network coordinator;
b) determining, by the network coordinator having received the request packet, whether to sequentially transmit an acknowledgement (ACK) packet indicating an acknowledged or unacknowledged state of the request packet and a data packet responding to the request packet to the network device; and
c) if it is determined that the ACK packet and the data packet should be sequentially transmitted, including, by the network coordinator, ACK information in a header of the data packet without transmitting the ACK packet to the network device, and transmitting the data packet including the header equipped with the ACK information to the network device.

7. The method according to claim 6, wherein the ACK information is contained in a frame control field of the header.

8. The method according to claim 7, wherein the ACK information is represented by only one bit from among a plurality of reserved bits contained in the frame control field.
